(19) United States
(12) Patent Application Publication
(10) Pub. No.: US 2009/0297067 A1
(43) Pub. Date: Dec. 3, 2009

(54) APPARATUS PROVIDING SEARCH SERVICE, METHOD AND PROGRAM THEREOF

(75) Inventor: Pil-seung YANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/268,624

(22) Filed: Nov. 11, 2008

(30) Foreign Application Priority Data
May 27, 2008 (KR) 10-2008-0049200

(51) Int. Cl. G06K 9/00

(52) U.S. Cl. 382/325

(57) ABSTRACT

An apparatus providing a search service, a search service method, and a program providing the search service method are provided. The apparatus providing the search service includes a display unit which displays a map image; and a control unit which, if a certain spot is selected on the map image, searches for a photographic image having a photographic range in which the selected spot is included and controls the display unit to display the photographic image.

### CROSS-REFERENCE TO RELATED APPLICATIONS

This application claims priority from Korean Patent Application No. 10-2008-0049200, filed on May 27, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying a widget window, and more particularly, to providing an apparatus providing a search service, a search service method, and a program providing the search service, and more particularly, to providing an apparatus providing a search service in which photographic images relevant to a certain spot on a map are provided to a user, a search service method, and a program providing the search service.

2. Description of the Related Art

In general, when a user searches for a desired spot using a map provided on-line or off-line, the user may frequently get lost due to having an incomplete understanding of the surrounding area even after getting near to the desired spot. In the related art, if a user selects a certain spot, there are services that map photographic images of the area surrounding the selected spot and then provide the mapped photos of the selected spot to the user.

However, the user cannot know the location and the direction of a photographing apparatus at the time of photographic images using the conventional services, so the user may have difficulty in understanding which place is photographed from the photographic images. In the case that the features of the surrounding area are changed, the user also may have difficulty in understanding which place is photographed from the photographic images. Consequently, the user may have difficulty in seeking the desired spot with ease, if the user uses the conventional services.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus providing search service, a search service method, and a program providing the search service method, which provide a use with photographic images relevant to the user's desired spot, so that the user can find the desired spot using a map with ease.

According to an aspect of the present invention, there is provided an apparatus providing a search service comprising a display unit which displays a map image; and a control unit which, if a certain spot is selected on the map image, searches for photographic images covering a photographic range in which the selected spot is included, and displays the selected spot on the display unit.

The photographic range may be determined by at least one of the location, the direction photographed, and the view angle of a photographing apparatus at the time of capturing the image.

The control unit may display the location at the time of photograph was taken, together with the selected spot on the map image.

The control unit may search for a photographic image in which a horizontal photographing direction and a vertical photographing direction face the selected spot, and the selected spot is included in a horizontal view angle or a vertical view angle, among pre-stored photographic images captured within a predetermined radius of the selected spot.

The apparatus providing a search service may further comprise a communication unit which communicates with an external server, whereby the control unit allowing the photographic images with the photographic ranges of the respective photographic images and transfers them to the external server through the communication unit.

The apparatus providing a search service may further comprise a storage unit, whereby the control unit matching the photographic images with the photographic ranges of the respective photographic images and stores them in the storage unit.

The apparatus providing a search service may further comprise an external apparatus connection unit which receives the photographic images and the photographic ranges of the respective photographic images from an external photographing apparatus.

The apparatus providing the search service may further comprise an instruction input unit which receives the photographic ranges of the photographic images.

The control unit may detect view angle by parsing metadata of the photographic image, check the photographic ranges of the respective photographic images using the detected view angle, and determine whether the checked photographic ranges include the selected spot.

The control unit may detect view angle information of a photographic image having the photographic range in which the selected spot is included and display it on the map image.

According to another aspect of the present invention, there is provided a search service method comprising displaying a map image, and if a certain spot is selected on the map image, searching for and displaying photographic images having a photographic range in which the selected spot is included.

The photographic range may be determined by at least one of the location, the photographing direction, and the view angle of a photographing apparatus at the time of capturing the image.

The searching and displaying may comprise displaying the location at the time the photograph is taken, together with the selected spot on the map image.

The searching and displaying may comprise searching for a photographic image in which a horizontal photographing direction and a vertical photographing direction face the selected spot, and the selected spot is included in a horizontal view angle or a vertical view angle, among pre-stored photographic images taken within a predetermined radius of the selected spot.

The search service method further comprises, prior to the displaying, matching the photographic images with the photographic ranges of the respective photographic images, and transferring them to an external server

The search service method further comprises, prior to the displaying, receiving the photographic images and the photographic ranges of the respective photographic images, and matching the photographic images with the photographic ranges of the respective photographic images and storing them.

The searching and displaying may comprise detecting view angle by parsing metadata of the searched for photographic image, checking the photographic ranges of the respective photographic images using the detected view angle, and determining whether the checked photographic ranges include the selected spot.

The searching and displaying may comprise detecting view angle information of a photographic image having a photographic range in which the selected spot is included and displaying the selected image on the map image.

According to another aspect of the present invention, there is provided a computer readable medium on which a program providing a searching service is stored, the search service comprising displaying a map image, and if a certain spot is selected on the map image, searching for and displaying a photographic image having a photographic range in which the selected spot is included.

The photographic range may be determined by at least one of the location, the photographing direction, and the view angle of a photographing apparatus at the time of taken the photograph.

The searching and displaying may comprise displaying the location at the time the photographing was taken, together with the selected spot on the map image.

The searching and displaying may comprise searching for a photographic image in which a horizontal photographing direction and a vertical photographing direction face the selected spot, and the selected spot is included in a horizontal view angle or a vertical view angle, from among pre-stored photographic images captured within a predetermined radius from the selected spot.

The computer readable medium on which the program providing the search service is stored may further comprises, prior to the displaying, matching the photographic images with the photographic ranges of the respective photographic images, and transferring them to an external server.

The computer readable medium on which the program providing the search service may further comprise, prior to the displaying, receiving the photographic images and the photographic ranges of the respective photographic images, and matching the photographic images with the photographic ranges of the respective photographic images and storing them.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram showing a schematic constitution of an apparatus providing a search service according to an exemplary embodiment of the present invention;

FIG. 2 is a view explaining a search service method according to an exemplary embodiment of the present invention;

FIG. 3 is a view explaining a method to register a photographic image in an apparatus providing a search service according to an exemplary embodiment of the present invention;

FIG. 4 is a flowchart explaining an operation of an apparatus providing a search service according to an exemplary embodiment of the present invention;

FIG. 5 is a block diagram showing a schematic constitution of an apparatus providing a search service according to an exemplary embodiment of the present invention; and

FIG. 6 is a flowchart explaining an operation of an apparatus providing a search service according to another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description such as the detailed construction and elements are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

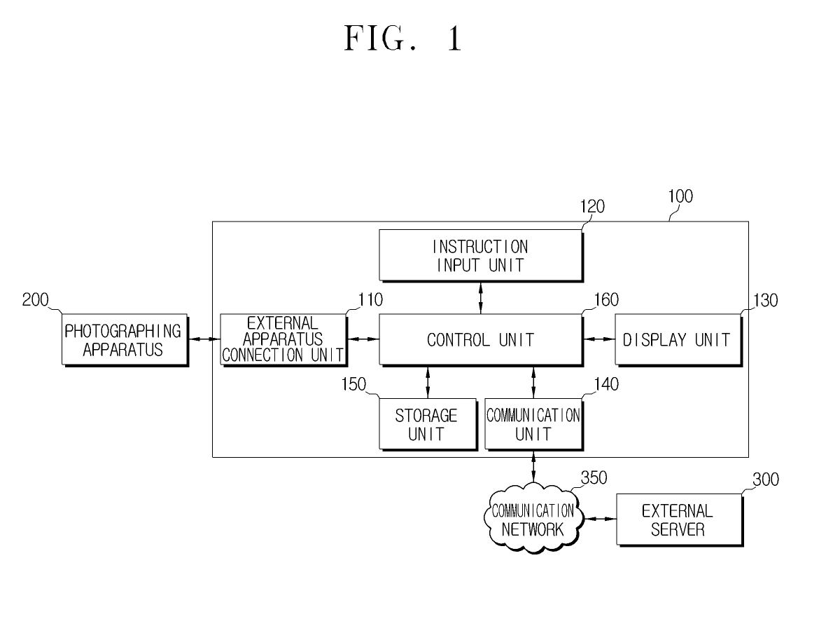

FIG. 1 is a block diagram showing a schematic constitution of an apparatus providing a search service according to an exemplary embodiment of the present invention.

Referring to FIG. 1, an apparatus 100 providing a search service comprises an external apparatus connection unit 110, an instruction input unit 120, a display unit 130, a communication unit 140, a storage unit 150, and a control unit 160.

The external apparatus connection unit 110 has a connection terminal to which an external apparatus, such as a photographing apparatus 200 can be connected, and receives photographic images and metadata relevant to the respective photographic images from the photographing apparatus 200. The metadata generally includes the dates on which photographs were taken, the image file size, the encoding formats, and various other parameters used by the photographing apparatus 200 at the time of capturing images. The metadata also includes the photographic range of a photograph, including information on the location, direction and view angle of the photographing apparatus 200 at the time of capturing images, and the photographic range is used in searching for photographic images by the control unit 106, which is described below.

The instruction input unit 120, which is used in receiving user instructions, may be implemented in various forms. For example, the instruction input unit 120 may be implemented in the form of a keyboard, a mouse, a remote controller, or a touch screen. In particular, a user may input the photographic range supplied by the photographing apparatus 200 at the time of capturing images into the apparatus providing the search service 100 using the instruction input unit 120. In other words, the photographic ranges of photographic images may not be included in the metadata, according to the sort of photographing apparatus 200. In that case, the user may directly input the location, direction, and view angle of the photographing apparatus 200 at the time of capturing images into the apparatus providing the search service 100 using the instruction input unit 120, without receiving the photographic range from the photographing apparatus 200 through the external apparatus connection unit 110.

The display unit 130 displays a map image and various parameters relevant to the map image, such as the scale, location coordinates, and distance. Also, a spot selected according to the user selection instructions is displayed on the map image, together with the location of the photographing apparatus 200 which photographs the corresponding spot. Furthermore, a photographic image having the photographic range in which the selected spot is included is displayed on the display unit 130 as a text list or a thumbnail list. When the instruction input unit 120 is implemented using a touch panel, the user may combine the instruction input unit 120 into the display unit 130 and may thus input the instructions by touching the image displayed on the display unit 130.

The communication unit 140 communicates with an external server 300 through a communication network 350. Here, the communication network 350 may include the Internet or a local area network (LAN), but the communication network 350 is not limited thereto. The communication unit 140 receives the map image stored in the external server 300 by the control unit 160, and various parameters relevant to the map image. The communication unit 140 also transmits the photographic images received in the apparatus providing a search service 100 and the photographic ranges of the photographic images to the external server 300. In the external server 300, the photographic ranges are stored so as to correspond to the respective photographic images.

The storage unit 150 stores a program providing a search service run by the apparatus providing the search service 100. Also, the storage unit 150 stores the map image and various parameters relevant to the map image, and stores the photographic images received by the apparatus providing the search service 100. The photographic ranges of the photographic images may be stored so as to correspond to the respective photographic images. In other words, in the case that the apparatus providing the search service 100 does not have a communication unit 140, the storage unit 150 may perform functions of the external server 300.

The control unit 160 controls constituents in the apparatus providing the search service 100 in order to perform search service functions. In other words, the control unit 160 receives the map image from the external server 300 using the communication unit 140 and displays the map image on the display unit 130, or controls the respective units 130, 140 and 150 so that the map image stored in the storage unit 150 is display on the display unit 130. The control unit 160 also controls the display unit 130 so that the spot selected according to the user selection instructions input using the instruction input unit 120 and the location from which the selected spot is photographed are displayed on the map image.

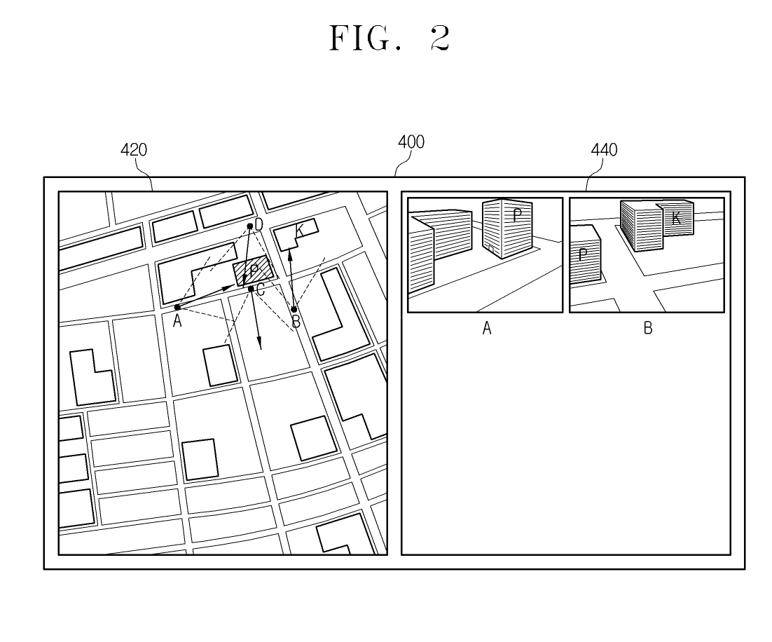

The control unit 160 transmits the photographic images received from the photographing apparatus 200 and the photographic ranges of the photographic images to the external server 300 using the communication unit 140, in order to allow the photographic images and the photographic ranges of the photographic images to be updated in the external server 300. Also, the control unit 160 allows the photographic images and the photographic ranges of the photographic images to be updated in the storage unit 150. The control unit 160 displays an image relevant to the selected spot from among the stored photographic images by performing a search based on the photographic ranges. The search function of the control unit 160 as described above will be described in more detail with reference to FIG. 2.

Referring to FIG. 2, a map image 420 and listed images 440 are displayed on a screen 400 of a display unit 130. It can be appreciated that photographic images relevant to spot P selected according to user selection instructions are captured from locations A and B. In other words, as shown in FIG. 2, the horizontal direction of a photographing apparatus 200 at location A is towards spot P and spot P is included in the horizontal view angle of the photographing apparatus 200. The horizontal direction of the photographing apparatus 200 at location B is towards spot K, however, spot P is included in the horizontal view angle of the photographing apparatus 200. At this time, a vertical direction of the photographing apparatus 200 faces spot P from locations A and B, or spot P is included in the vertical view angle of the photographing apparatus 200.

As described above, the control unit 170 may search for a photographic image having a photographic range which includes spot P selected with reference to the location, direction, and view angle of the photographing apparatus 200 at the time of capturing the image. In other words, the control unit 160 receives a photographic image having a photographic range in which spot P selected with reference to the location, direction, and view angle of the photographing apparatus 200 at the time of capturing the image is included from an external server 300 or reads it from a storage unit 150, making it possible to display the photographic image on the display unit 130 in a list of images 440, as shown in FIG. 2.

Meanwhile, the photographing apparatus at location C is facing in a direction opposite that of spot P, so spot P is not included in the horizontal view angle of the photographing apparatus 200. In other words, since spot P is not included in the photographic range of the photographing apparatus 200 at the location C, the control unit 160 determines that the photographic image captured from the location C is not related to spot P.

The photographing apparatus at location D faces spot P, so spot P is included in the horizontal view angle of the photographing apparatus 200. However, since spot P is not included in the vertical view angle, the control unit 160 determines that the photographic image captured from location D is not related to spot P.

Here, the location where spot P is photographed may be within a radius of several meters or several kilometers from spot P, and the control unit 160 determines that an image captured from the location out of this radius is not related to spot P. In other words, the control unit 160 searches for a photographic image relevant to the selected spot from among the images captured within a predetermined radius from the selected spot P, in consideration of the photographing direction and view angle.

FIG. 2 shows buildings as an example, but, spots selectable by the user are not limited to buildings. Also, the spot P and the locations A, B, C, and D may use an independent coordinate system and a reference coordinate system, such as latitude or longitude, and may further use any systems capable of representing the location. The horizontal view angle is commonly provided as metadata of the photographing apparatus 200, and the vertical view angle may be obtained by the user using, for example, a level. However, the method to obtain the photographic ranges, which include the location, horizontal direction, vertical direction, horizontal view angle, and vertical view angle used in the present invention, is not limited thereto.

When the view angle is provided as metadata of the photographing apparatus 200, the control unit 160 parses the metadata of the photographic image to detect the view angle, checks the photographic range of each photographic image using the detected view angle, and determines whether the checked photographic range includes spot P. As shown in FIG. 2, the user may visually check the photographic range, by checking the view angles of the respective locations on the map image 420.

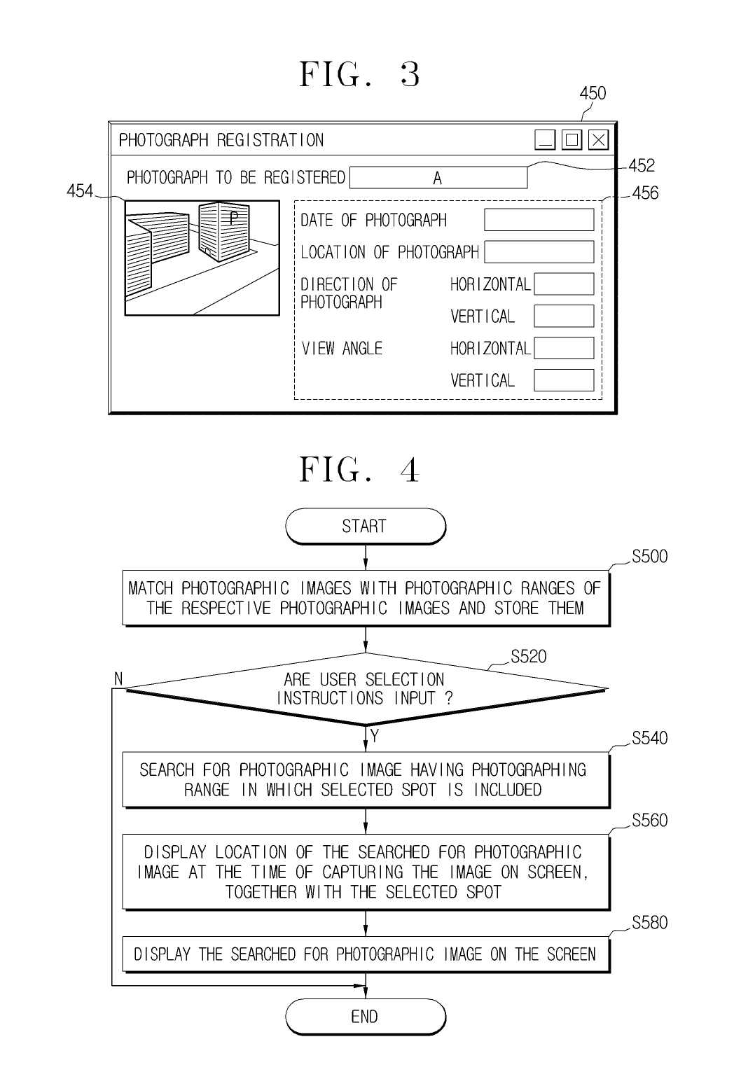

FIG. 3 is a view explaining a method to register a photographic image in an apparatus providing a search service according to an exemplary embodiment of the present invention.

Referring to FIG. 3, a photograph registration screen 450 includes a photograph selection window 452 which selects a photograph to be registered, a preview window 454 which displays the selected photograph, and a photographic range input window 456 which inputs the photographic range of the selected photograph.

As shown in FIG. 3, a user may make a photographic image of spot P correspond to a certain photographic range, and the photographic image and the corresponding photographic range may be transmitted to an external server 300 or stored in a storage unit 150.

FIG. 3 shows a photograph as the photographic image, in other words, a still image, by way or example, but, the photographic image may also be a moving image instead of a still image.

FIG. 4 is a flow chart explaining an operation of an apparatus providing a search service according to an exemplary embodiment of the present invention.

Referring to FIG. 4, first, a control unit 160 matches photographic images to photographic ranges of the respective photographic images and stores them (S500). In other words, the control unit 160 stores the photographic images received from a photographing apparatus 200 and the photographic ranges of the photographic images in the storage unit 150 or transmits them to an external server 300 through a communication unit 140.

Here, if user selection instructions are input (S520-Y), the control unit 160 searches for a photographic image having a photographic range including a selected spot (S540). For example, the control unit 160 searches for a photographic image in which a horizontal direction and a vertical direction face the selected spot, and the selected spot is included in a horizontal view angle or a vertical view angle, from among photographic images captured within a predetermined radius of the selected spot.

The control unit 160 displays the location of the searched for photographic image at the time of capturing the image on a screen, together with the selected spot (S560). In other words, the control unit 160 displays the spot selected by the user on a map image, and controls the control unit 130 so that the photographic image selected in step 540 is displayed on the map image.

Finally, the control unit 160 displays the searched for photographic image on the screen (S580). In other words, the control unit 160 controls the photographic image searched for in step S540 to be displayed on the display unit 130 by reading it from a storage unit 150 or receiving it from an external server 300.

The user may search for and check the photographic image relevant to the selected spot with ease through the process described above.

The photographic image referred to in one embodiment of the present invention may be a still image such as a photograph, or a moving image.

FIG. 5 is a block diagram showing a schematic constitution of an apparatus providing a search service according to an exemplary embodiment of the present invention.

Referring to FIG. 5, an apparatus providing a search service 600 comprises a control unit 620 and a display unit 640.

The display unit 640 displays a map image and various parameters relevant to the map image, such as the scale, coordinates, and distance and the like. Also, a spot selected according to user selection instructions is displayed on the map image, together with the location of a photographing apparatus which photographs the corresponding spot. Furthermore, photographic images including the selected spot within their photographic ranges may be displayed on the display unit 640 as a text list or a thumbnail list.

If a certain spot is selected on the map image, the control unit 620 searches for a photographic image having a photographic range including the selected spot and displays it on the display unit 640. Also, the control unit 620 controls the display unit 640 in order that the spot selected according to user selection instructions, which is input, and the location of a photographing apparatus which photographs the selected spot are displayed on the map image. Moreover, the control unit 620 matches photographic images with photographic ranges of the respective photographic images so that the matched photographic ranges may be used when searching for the photographic images.

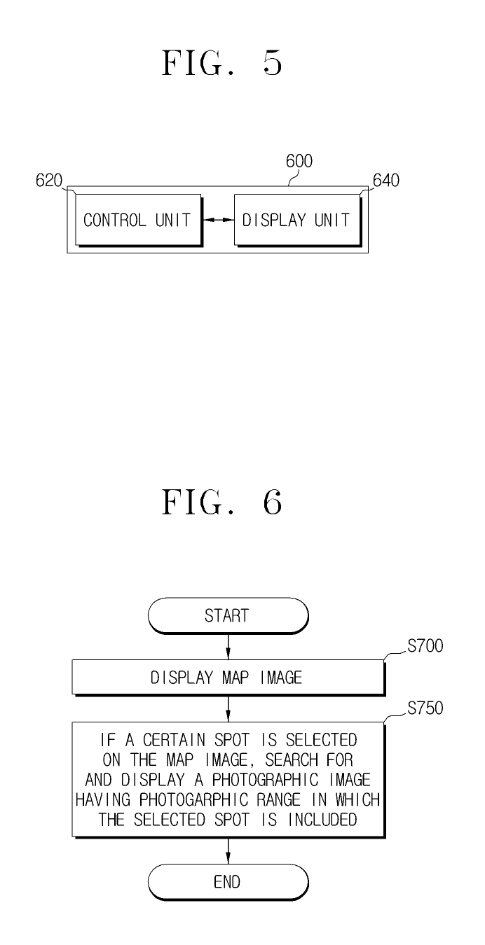

FIG. 6 is a flow chart explaining an operation of an apparatus providing a search service according to another exemplary embodiment of the present invention.

Referring to FIG. 6, first, a control unit 620 controls a display unit 640 so as to display a map image (S700). If a certain spot is selected on the map image, a photographic image having a photographic range in which the selected spot is included is searched for and controlled to be displayed on a display unit 640 (S750).

Search for photographic images associated with the map image can be made through the process described above.

As described above, according to the exemplary embodiments of the present invention, management and search for a photographic image associated with a map image are made, making it possible to easily update photographic images relevant to a spot selected by a user or to provide the photographic images to another user. Also, an image relevant to the spot selected by the user with reference to the location, direction, and view angle of a photographing apparatus at the time an image captured is searched for and provided, so the user may know of changes in the surrounding area of the corresponding spot and may even know invisible features of the surrounding area hidden by geographical features or buildings, if the photographing apparatus is used interacting with a geographic information system (e.g., global positioning system (GPS)), making it possible to seek a corresponding spot with ease with reference to the map image.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An apparatus providing a search service comprising:
a display unit which displays a map image; and
a control unit which, if a certain spot is selected on the map image, searches for a photographic image having a photographic range in which the selected spot is included and controls the display unit to display the photographic image.

2. The apparatus as claimed in claim 1, wherein the photographic range is determined by at least one of a location, a direction, and a view angle of a photographing apparatus at a time of capturing the photographic image.

3. The apparatus as claimed in claim 1, wherein the control unit controls the display unit to display a location at a time the photographic image was captured, together with the selected spot on the map image.

4. The apparatus as claimed in claim 1, wherein the control unit searches for a photographic image, in which a horizontal direction and a vertical direction face the selected spot, and the selected spot is included in a horizontal view angle or a vertical view angle, from among pre-stored photographic images captured within a predetermined radius of the selected spot.

5. The apparatus as claimed in claim 1, further comprising:
a communication unit which communicates with an external server,
wherein the control unit matches photographic images with photographic ranges of the respective photographic images and transfers the photographic images to the external server through the communication unit.

6. The apparatus as claimed in claim 1, further comprising:
a storage unit,
wherein the control unit matches photographic images with photographic ranges of the respective photographic images and stores the photographic images in the storage unit.

7. The apparatus as claimed in claim 1, further comprising:
an external apparatus connection unit which receives photographic images and photographic ranges of the respective photographic images from an external photographing apparatus.

8. The apparatus as claimed in claim 1, further comprising:
an instruction input unit through which the photographic range of the photographic image is input.

9. The apparatus as claimed in claim 1, wherein the control unit detects a view angle by parsing metadata of the photographic image, checks the photographic range of the photographic image using the detected view angle, and determines whether the checked photographic range includes the selected spot.

10. The apparatus as claimed in claim 1, wherein the control unit detects view angle information of the photographic image having the photographic range in which the selected spot is included and controls the display unit to display the photographic image on the map image.

11. A search service method comprising:
displaying a map image; and
if a certain spot is selected on the map image, searching and displaying a photographic image having a photographic range in which the selected spot is included.

12. The method as claimed in claim 11, wherein the photographic range is determined by at least one of a location, a direction, and a view angle of a photographing apparatus at a time of capturing the photographic image.

13. The method as claimed in claim 11, wherein the searching and the displaying comprises displaying a location at a time of capturing the photographic image, together with the selected spot on the map image.

14. The method as claimed in claim 11, wherein the searching and the displaying comprises searching for a photographic image, in which a horizontal direction and a vertical direction face the selected spot, and the selected spot is included in a horizontal view angle or a vertical view angle, from among pre-stored photographic images captured within a predetermined radius of the selected spot.

15. The method as claimed in claim 11, further comprising, prior to the displaying, matching photographic images with photographic ranges of the respective photographic images and transferring the photographic images to an external server.

16. The method as claimed in claim 11, further comprising, prior to the displaying,
receiving photographic images and photographic ranges of the respective photographic images; and
matching the photographic images with the photographic ranges of the respective photographic images and storing the photographic images.

17. The method as claimed in claim 11, wherein the searching and the displaying comprises detecting a view angle by parsing metadata of the photographic image, checking the photographic range of the photographic image using the detected view angle, and determining whether the checked photographic range include the selected spot.

18. The method as claimed in claim 11, wherein the searching and the displaying comprises detecting view angle information of the photographic image having the photographic range in which the selected spot is included and displaying the photographic image on the map image.

19. A computer readable medium which stores a program providing a searching service, the searching service comprising:
displaying a map image; and
if a certain spot is selected on the map image, searching for and displaying a photographic image having a photographic range in which the selected spot is included.

20. The computer readable medium as claimed in claim 19, wherein the photographic range is determined by at least one of a location, a direction, and a view angle of a photographing apparatus at a time of capturing the image.

21. The computer readable medium as claimed in claim 19, wherein the searching and the displaying comprises displaying a location at a time of capturing the photographic image, together with the selected spot on the map image.

22. The computer readable medium as claimed in claim 19, wherein the searching and the displaying comprises searching for a photographic image in which a horizontal direction and a vertical direction face the selected spot, and the selected spot is included in a horizontal view angle or a vertical view angle, from among pre-stored photographic images captured within a predetermined radius of the selected spot.

23. The computer readable medium as claimed in claim 19, further comprising, prior to the displaying, matching photographic images with photographic ranges of the respective photographic images and transferring the photographic images to an external server

24. The computer readable medium as claimed in claim 19, further comprising, prior to the displaying,
receiving photographic images and photographic ranges of the respective photographic images; and
matching the photographic images with the photographic ranges of the respective photographic images and storing the photographic images.
